(19) United States
(12) Patent Application Publication
(10) Pub. No.: US 2015/0124051 A1
(43) Pub. Date: May 7, 2015

(54) Methods and Apparatus for Enhanced Reality Messaging

(71) Applicant: Robert Schinker, Commerce Township, MI (US)

(72) Inventor: Robert Schinker, Commerce Township, MI (US)

(21) Appl. No.: 14/474,933

(22) Filed: Sep. 2, 2014

Related U.S. Application Data
(63) Continuation-in-part of application No. 14/071,822, filed on Nov. 5, 2013.

(51) Int. Cl. G03H 1/08; H04L 29/08; G03H 1/00

(52) U.S. Cl. CPC G03H 1/0866; G03H 1/0005; H04L 67/02; H04L 67/104; G03H 2001/0088
USPC 348/40

(57) ABSTRACT

A method for delivering an enhanced reality message includes recording a holographic image displayed on a matte surface with the built in camera of a mobile electronic device, such as a web-cam, tablet, smartphone, iPhone or the like. The camera takes a photo of the marker and software in an app of the electronic device produces a calibration reference based on the specific marker. The user selects, accesses, and downloads a holographic image from a library of unsealed holograms stored on the mobile device, whereupon the software in the app rescales the selected image as well as all unselected images in the library. The image is recorded and saved for future access, and, if desired, uploaded to the internet for sharing via an e-mail or social media directly from the software. The unsealed holographic image is calibrated, or scaled, to the size of any selected matte surface to create a “life size” image when projected thereonto.

### CROSS REFERENCE TO RELATED APPLICATIONS

This application claims priority from and is a continuation in-part of co-pending U.S. patent application Ser. No. 14/071,822, titled “Method and Apparatus for Enhanced Reality Messaging”, filed Nov. 5, 2013 by the inventor herein, the disclosure of which is hereby incorporated by reference in its entirety, including the drawings thereof.

This application is related to co-pending U.S. patent application Ser. No. 13/709,158, titled “Methods and Apparatus for Enhanced Reality Messaging” (“the Prior Application”), filed Dec. 10, 2012 by the inventor herein, the disclosure of which is hereby incorporated by reference in its entirety including the drawing.

### BACKGROUND OF THE INVENTION

1. Field of the Invention

This invention relates generally to methods and apparatus for sending and receiving messages and, more particularly to methods and apparatus particularly suitable for sending and receiving enhanced or augmented life sized augmented reality audio-visual representations through a mobile device.

2. Prior Art

In the above-referred to co-pending Prior Application there is disclosed an apparatus and method for sending of holographic picture postcards. According to that invention, internet-connected cell phones, cameras, and computers, and similar electronic devices are used to send an audio-visual “post card” message to a recipient. While the invention defined thereon is efficacious, the “post card” is still a “miniaturized” message that is difficult to share with friends, etc.

The present invention enhances the aforementioned system by providing a social media friendly system for transmitting enlarged holographic-based messages through a mobile device.

There exists a need for a method to adjust the size of an element(person, character or object) being super-imposed via what is commonly referred to as “augmented reality”, onto a video, such that the element is scaled to a desired size relative to the environment being seen in the video.

This is particularly important when allowing the user to identify their own marker. In “Augmented Reality”, the size of the element being super-imposed is always relative to the marker or target being used. Since the size of a user generated marker or target may vary widely, it is important to be able to adjust the scale of the super-imposed element relative to the said marker, so that it remains the desired size within the environment seen in the video.

For example, if one wishes to have a 6′ tall person appear life size as the element in an augmented reality video and the marker being used is 2′ wide, the height of the person (element) will be 3× the width of the marker. Now if the same 6′ tall person is viewed with a marker that is only 1′ wide, then without the ability to adjust the scale of the element, the person would appear to only be 3′ tall. In this case, it is desirable to adjust the size ratio of the element to the marker, from 3× to 6×.

### SUMMARY OF THE INVENTION

According to the present invention, there is provided an enhanced internet through a downloadable app message system. The message system hereof is based on the use of a mobile device which is used to access via the internet, a library of holographic images which are displayable on a suitable marker.

The marker is preferably a matte surface or pad which is used to project a holographic image thereon.

The software associated with the app detects the surface and is configured to detect changes in the field of view of the camera associated with the image and superimposes an image of the hologram on the marker.

In a first aspect of this invention, the software positions the hologram relative to the marker. The hologram, also, stays constant in size relative to the marker as a consequence of being pre-calibrated before being placed in the library.

The recording is done directly on the mobile device and creates a multimedia stream representing an enhanced or augmented reality message.

The recording of the enhanced or augmented reality multimedia stream, once finished, can then be shared via e-mail or social media directly from the app that is used to view, and download the hologram.

As noted, the library of holograms is internet or web-based and is accessed via an app stored on the suitable device, e.g. computer, smartphone, tablet, pad and the like. Once accessed the selected image is downloaded or projected onto the surface.

When viewed, a 2D video with a transparent marker is maybe oriented in a 3D environment approximately perpendicular to the marker to create the illusion that a person is standing on top of the marker.

In a second aspect of the present invention, as before, there is provided an enhanced internet through a downloadable app message system wherein the mobile device, such as a computer, laptop, smartphone, tablet, pad and the like, is used to access, via the internet, a library of holographic images, which are displayable on a suitable marker. The marker is a matte surface or pad which is used to display a holographic image thereon.

Importantly, according to this aspect of the invention, the marker may vary in size and shape relative to the holographic images that the user may select from a library of selectable images. Preferably, the marker is a flat surface and may be irregular in shape. Generally, any marker surface is acceptable except those having a black surface or one with a repeating pattern.

Further, the holographic images that are stored in the library are not pre-calibrated but unsealed prior to use and when selected for use are “calibrated” or “scaled” to be right-sized relative to the size of the marker used to calibrate the holograms.

A photo of the marker image is taken and recorded. The software associated with the app detects the matte surface and is configured to detect changes in the field of view of the camera associated with the holographic images. The software in the app adjusts or “calibrates” the scale or shape of the marker image. Once the photo is taken, the software calibrates or scales all holographic images stored in the database of the library relative to the specific marker.

A holographic image is selected from the library of images, which image is then calibrated by the app to reflect the size or scale to that of the marker. Again, the library of holograms is internet based and is accessed via an app stored on the mobile device. Once accessed the calibrated selected image is projected onto the marker surface. The environment with calibrated image is then recorded and the recording saved.

If the user changes the marker and surrounding environment, the adjustment and scaling or calibrating process of the images in the library is repeated and image resealed for use with the new and different marker.

As noted above, the recording of the enhanced or augmented reality multimedia stream is done directly on the mobile device and creates a multimedia stream representing an enhanced or augmented reality message. Once finished, the recording can then be shared via e-mail or social media directly from the app that is used to view and download the hologram, or stored.

The present system and method contemplates the inclusion an auxiliary image of the environment surrounding the marker.

Additional features of the present invention are described in the detailed description, the accompanying drawings, or both.

The foregoing summary, as well as the following detailed description of certain embodiments of the present invention, will be better understood when read in conjunction with the appended drawings.

### BRIEF DESCRIPTION OF THE DRAWINGS

FIG. 1 is a representation of an environment for producing the recording hereof, according to a first embodiment of the invention.

FIG. 2 is a flowchart showing a method useful in conjunction with the first embodiment of the present invention.

FIG. 3 is a flowchart showing a method useful in conjunction with a second embodiment of the present invention; and

FIG. 4 is a representation of a mode for scaling the image to the marker.

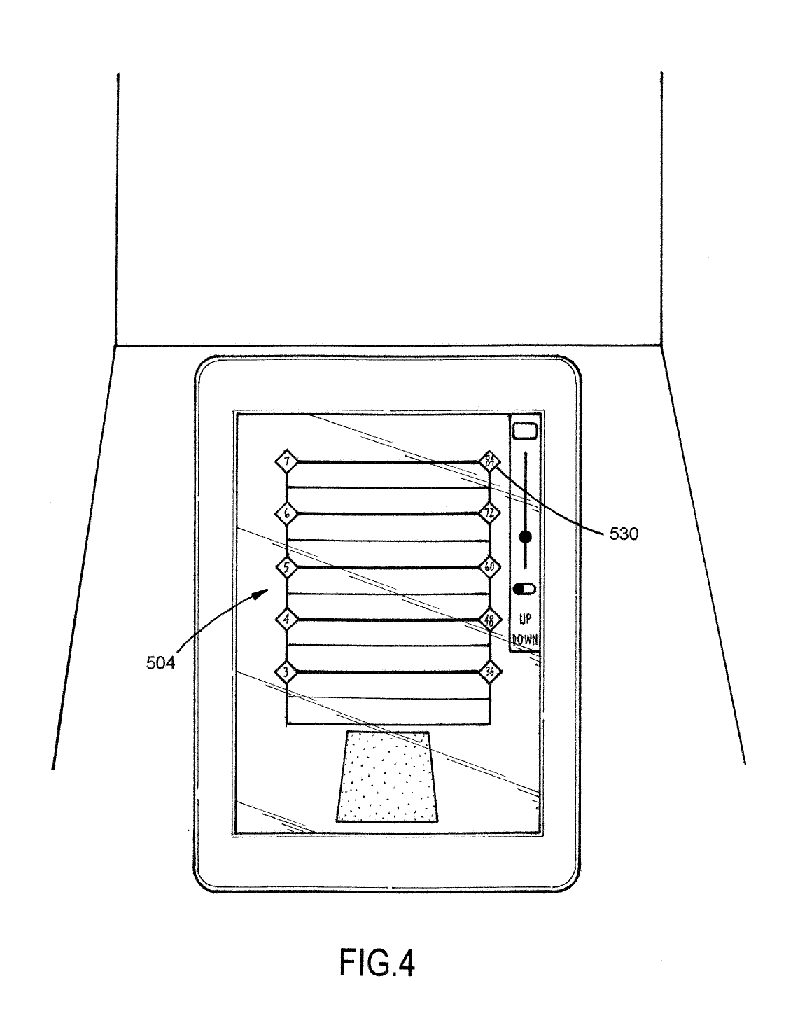

### DETAILED DESCRIPTION OF THE PREFERRED EMBODIMENT

As used herein, an element or step recited in the singular and preceded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The present invention contemplates simultaneous recording and viewing of a recording which recording is saved so that, when finished, it can be posted to a network, such as a social media or to a website on the internet.

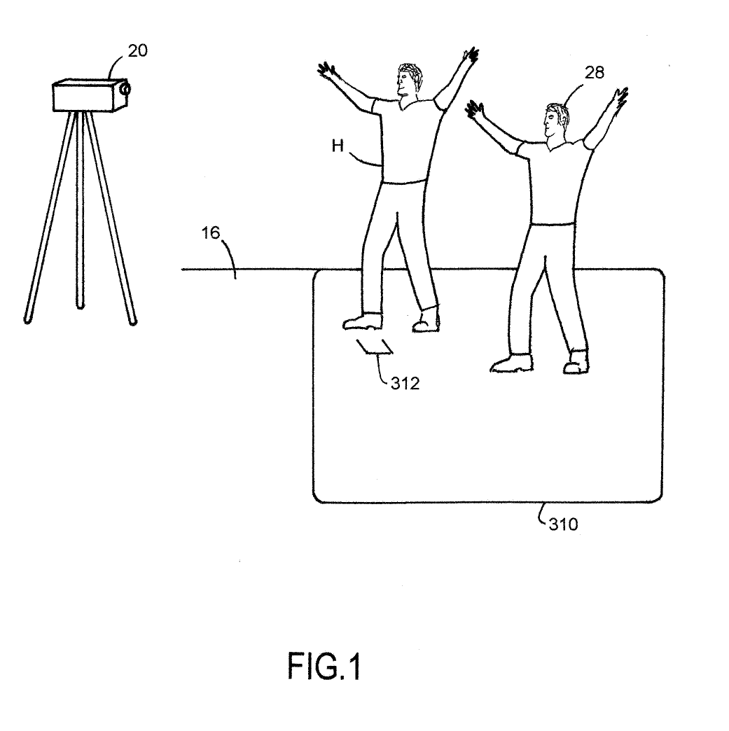

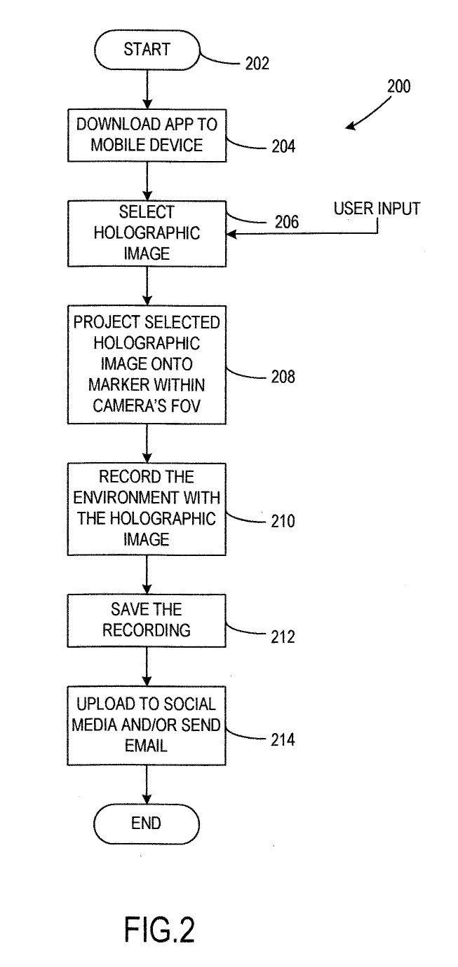

Referring to FIGS. 1 and 2, a first embodiment of this invention is disclosed.

In FIG. 1, in accordance with the present system, an apparatus for enhanced reality messaging includes a matte surface 310 such as an enlarged pad having a marker 312. The pad is used to determine the position and size of a holographic image within the field of view of a camera of a mobile device or camera 20. The pad need not have codes printed or used thereon, but instead is used for recording of the enhanced reality message.

The pad 310, when acquired may include for downloading to a mobile audio-visual communication device, (e.g. an IPHONE, IPAD, a tablet, or computer, or laptop computer) the software required to create enhanced reality images from the hologram library. Otherwise, the requested software is obtained by downloading a web-based app directly to the mobile devices.

Regardless of how the app is obtained, it is used to access a library of holographic images. Once the matte surface is deployed and a selected hologram H is projected thereon, the camera 20 within the mobile device or webcam is used to record a scene. The recording is done within any desired selected environment. Regardless of the environment, the background is essentially unchanging.

A person 28 may inject himself or herself into the recording by positioning himself or herself with the field of view of the camera. During recording, an external video or forward facing camera of the mobile device enables the user or person 28 to see himself or herself as the enhanced reality message is being created, to allow the person 28 to appropriately position himself or herself within the environment.

Optionally, a positioning guide or other indicator may be placed on a floor 16 where pad is located to provide a guide for placement of the person 28 making the recording.

As noted above, a holographic scene or image, or hologram, itself, is accessed via a web-based downloadable app onto a suitable device, e.g. mobile device. The hologram is stored in a library of holograms.

The user or person accesses the library and downloads and projects the desired hologram or holographic image onto the marker 312 provided on the surface 310. The library of holographic image is pre-calibrated to the size of the marker such that, any selected one is displayed on the mat as “life-sized”.

In any event, after the recording is finished it may be uploaded to social media sites or sent by e-mail such as FACEBOOK or YOUTUBE, either by downloading the recordings onto a computer and uploading it to these sites via the internet 50 or directly from the app.

FIG. 2 is a flowchart 200 showing the method hereof and which starts at entry point 202. The user 28 downloads the app for selecting the hologram at 204. The entry point starts where the pad 310 is placed in an environment. The mobile device is then used to access the library and select the desired hologram, at 206. The hologram H is then projected at 208 onto the marker 312 using either the device's camera or a web-cam. Thereafter the person 28 makes the recording at 210.

As noted above, the hologram is pre-calibrated within the library to create a “life sized” image in relation to the size of the marker 312.

These may include images of humans, animated persons, etc. clips of old movie films, clips of sports or political scenes, clips of TV shows, etc. At step 208, the holographic image that is selected (e.g., a still image from the beginning of the holographic image in some embodiments) is superimposed onto matte.

Necessarily, the marker has to be right sized so that the image is pre-calibrated directly relative to the size of the marker.

As shown, the person or user 28 may inject himself or herself into the field of view of the camera 20. On command the recording is produced in which the changing portion of the field of view of camera 20 is captured. Simultaneously an audio may be created via the microphone of the camera 20.

The recording may be previewed in real time on a video monitor or TV or the like.

In any event, the recording is performed at step 212. At step 214, the recording is shared via e-mail or social media by uploading the recording directly from the app to the social media service such as FACEBOOK, YOUTUBE, and/or TWITTER, by way of example.

The social media website, preferably, is a website or e-mail selected by either the user or the sharer. The particular social media is not critical hereto. It is only the ability to share the recording via a social network or by e-mail that is important.

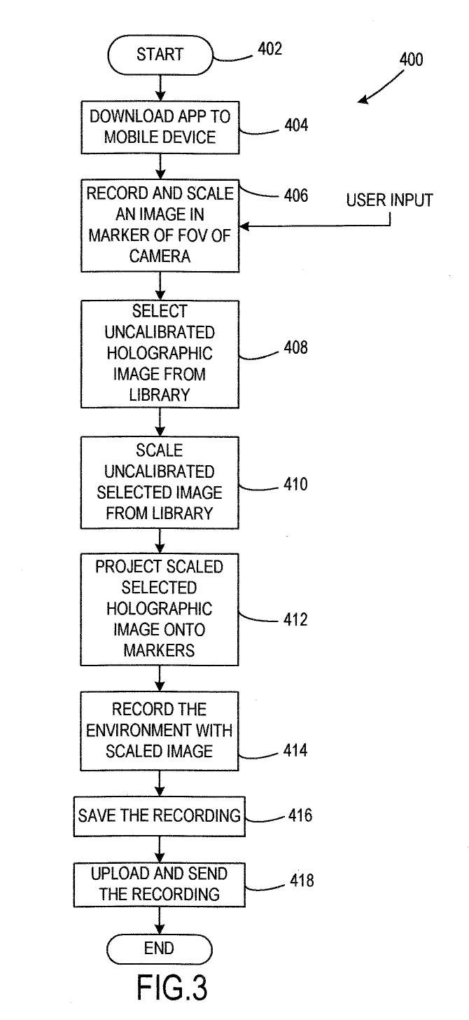

In a second embodiment of this invention, an apparatus and method is disclosed wherein the holographic images are not selected from a library of pre-calibrated images but the images are unsealed and then right sized relative to any given marker, the marker being recorded and then used to calibrate the holographic image. The apparatus and method will now be discussed and the method summarized by the flowchart of FIG. 3.

As before, the invention includes the matte surface 310 such as an enlarged pad having a marker 312. The pad is used to determine the position and size of a holographic image within the field of view of a camera of a mobile device or camera 20. The pad need not have codes printed or used thereon, but instead is used for recording of the enhanced reality message.

The pad may be of any size, shape, flat, and the upper target surface 310 thereof have indicia or images thereon. For example, the marker may be the front page of a newspaper and form the recorded environment of the message. Preferably, the surface 310 is not black or has a repeating pattern.

The pad 310 may be recorded and downloaded to a mobile audio-visual communication device, (e.g. an IPHONE, IPAD, tablet, computer, laptop computer) the software required to create enhanced reality images from the hologram library. Otherwise, the requested software is obtained by downloading a web-based app directly to the mobile devices.

Regardless of how obtained, the app is used with the camera to record the marker and use the recorded image of the marker to provide a calibration reference for calibrating unsealed holograms. The app is used to access a library of uncalibrated or holographic images not right sized relative to the matte. The holographic images must be scaled or calibrated relative to the reference marker.

A hologram is selected and the app operates to calibrate or right sixe the selected hologram and all of the holographic images in the library for use with this specific marker. Once calibrated, the selected image is projected onto the marker and the camera 20 within the mobile device or webcam is used to record a scene. The recording is done within any desired selected environment. Regardless of the environment, the background is essentially unchanging.

A person 28 may inject himself or herself into the recording by positioning himself or herself with the field of view of the camera. During recording, an external video or forward facing camera of the mobile device enables the user or person 28 to see himself or herself as the enhanced reality message is being created, to allow the person 28 to appropriately position himself or herself within the environment.

Optionally, a positioning guide or other indicator may be placed on a floor 16 where pad is located to provide a guide for placement of the person 28 making the recording.

In any event, after the recording is finished it may be uploaded to social media sites or sent by e-mail such as FACEBOOK or YOUTUBE, either by downloading the recordings onto a computer and uploading it to these sites via the internet 50 or directly from the app.

FIG. 3 is a flowchart 400 showing the method hereof and which starts at entry point 402. The entry point starts where the pad 310 is placed in an environment. The user 28 downloads the app for selecting the hologram at 404. The mobile device is then used at 406 to record and calibrate an image of the marker within the camera field of view.

The user accesses the library of potential holograms, at 408, and selects a desired hologram H . . . Initially, none of the holographic images in the library, including the selected hologram H, are calibrated or of proper scale (“right-sized”) relative the marker. At 410, the software in the app calibrates or scales the selected hologram H to conform to the calibrating image of the pad or marker, as well as calibrating and scaling all other holographic images in the library to be “right-sized” and compatible for use with the selected marker. The holograms are thus pre-calibrated within the library to create a “life sized” image for projection in relation to the size of the marker 312.

At 412, the calibrated hologram H is then projected onto the marker 312 using either the device's camera or a web-cam. Thereafter, at 414, the person 28 makes a recording of the environment with the now calibrated holographic image.

As show in FIG. 5, the image is scaled to the marker wherein the display or setup screen such as an iPad, displays the scale.

As shown, an element 500 indicating measurement (inches or cm) appears on the screen 502 of a device having the downloadable app. The user either uses the on screen slider 504, or simply touches the screen with two fingers to expand or contract the size to match a real world object of known size. For instance, the marker could be set on the floor near a doorway that is known to be 7′ tall. The element with the measurements may be scaled such that the 7′ indicator on the element matches the top of the known 7′ doorway. All elements in the application will then be sized relative to the measurement element.

Although not shown, an alternative to the measuring element, i.e., video, may be offered, in that at the start of each interaction, the user could preview a still or moving image of the element to be used. During this preview, the user may use one of several methods known in the art to adjust the scale of the element to the desired size within the real world video environment. This is done without the aid of the dedicated measuring element. Here, the user would simply size the person within the environment being seen by the camera, to the size that the user desires by pinching the screen or expanding the screen as similar methods.

Upon scaling any one element, be it the measuring element, or the preview of one of the elements available within the software, the scale selected will be persistent and be applied to all elements in the software. The scale can be changed by the user, at which time the new scale will be applied to all elements.

As noted before, the environment may include images of humans, animated persons, etc. clips of old movie films, clips of sports or political scenes, clips of TV shows, etc.

The person or user 28 may inject himself or herself into the field of view of the camera 20. On command the recording is produced in which the changing portion of the field of view of camera 20 is captured. Simultaneously an audio may be created via the microphone of the camera 20.

The recording may be previewed in real time on a video monitor or TV or the like.

At step 416 the recording is stored.

Preferably the recording and storing of the recording are simultaneous.

The recording, at step 418, is shared via e-mail or social media by uploading the recording directly from the app to the social media service such as FACEBOOK, YOUTUBE, and/or TWITTER, by way of example.

The social media website, preferably, is a website or e-mail selected by either the user or the sharer. The particular social media is not critical hereto. It is only the ability to share the recording via a social network or by e-mail that is important.

It will thus be appreciated that method and apparatus embodiments disclosed herein provide enhanced messages that provide a substantial visual impact on recipients of such messages. While the invention has been described in terms of various specific embodiments, those skilled in the art will recognize that the invention can be practiced with modification within the spirit and scope of the claims.

What is claimed is:

1. An enhanced messaging system comprising:
a) a matte surface defining a marker and having a predetermined shape and surface;
b) a mobile device including:
(i) a camera configured to generate a live video signal and to record the same video signal to create a recording;
(ii) means for recording an image of the marker and producing reference parameters reflective of the marker configuration,
(iii) means for accessing a downloadable holographic image from a web-based library of unsealed holographic images;
(iv) means for right sizing and calibrating an accessed unsealed image to correspond to the reference parameters and configuration of the marker; and
(v) means for projecting a downloaded right sized holographic image onto the marker within the field of view of the camera;
c) means for storing the recording simultaneously with the recording thereof; and
d) means for directly uploading the recorded image to a social media.

2. The messaging system of claim 1 wherein the means for accessing is a web-based downloadable software application accessible by the mobile device.

3. The messaging system of claim 1, wherein the mobile device is selected from the group of a computer, a tablet, an IPHONE, or an IPAD.

4. A method for delivering an enhanced reality message, said method comprising:
a) providing a mobile electronic device, said device including a camera configured to generate a live video signal stream and to record the same video signal to create a recording, and a web-based software application (“app”) for accessing a downloadable holographic image from an internet library of unsealed holographic images;
b) providing a marker for displaying a holographic image;
c) recording the marker with the camera, the app providing the recording with a calibration reference scale based on the size of the specific marker recorded;
d) selecting an unsealed holographic image from the library with the camera, the app referencing the recording of the marker and calibrating and scaling both the holographic image selected and all images in the library in a manner to be the right size and correspond to the size of the recorded marker;
e) projecting the calibrated holographic image onto the marker to produce an enhanced reality multi-media message; and
f) recording and saving the recording to an internet based website.

5. The method of claim 4, said method further comprising uploading and sharing the enhanced reality multi-media message recording via a social media or e-mail, wherein the holographic image is calibrated relative to the size of the marker to create a life size image thereof in relation to the marker size.

6. The method of claim 4 wherein the marker is a matte surface held in view of a camera of the mobile device.

7. The method of claim 4, said method further comprising injecting a person into the recording by positioning the person within the field of view of the camera.

8. The method of claim 7, said method further comprising placing a positioning guide relative to the marker, wherein to provide a guide for placement of the person making the recording a selected life-size holographic image.

9. The method of claim 5, said method further comprising simultaneously producing an audio signal with the recording of the right sized holographic marker, the audio being produced via a microphone of the camera.

10. A method for delivering an enhanced reality message, said method comprising:
providing a mobile electronic device, which includes a video camera,
downloading a web-based software application (“app”) for accessing a library of holographic images,
providing a marker for displaying a holographic image,
recording the marker,
accessing a holographic image from the library,
projecting the holographic image onto the marker, the size of the projected image being right sized relative to the size of the marker by the app such that any holograph displayed on the marker is life sized,
recording the projected holographic image and associated environment of the marker with the camera, and
storing the recording.

11. The method of claim 10, said method further comprising sharing the enhanced reality recording via a social media or e-mail.

12. The method of claim 10, wherein the holographic images are pre-calibrated relative to the size of the marker to create a life size image thereof in relation to the marker size.

13. The method of claim 10, wherein the holographic images are uncalibrated relative to the size of the marker prior to being accessed from the library of holographic images, the step of recording the marker with the camera using the app to provide the recording with a calibration reference scale based on the size of the specific marker recorded, and the step of selecting an uncalibrated holographic image from the library with the camera using the app calibrating and scaling both the holographic image selected and all images in the library in a manner to be the right size and correspond to the size of the recorded marker.

14. The method of claim 10, wherein the marker is a matte surface held in view of a camera of the mobile device.
